(19) United States
(12) Patent Application Publication
(10) Pub. No.: US 2012/0284972 A1
(43) Pub. Date: Nov. 15, 2012

(54) Belt Buckle Accessory

(76) Inventors: Jane E. Hafdal, Alexandria, MN (US); Diane R. Ford, Minnetonka, MN (US); Linda Wolfe, Stacy, MN (US); Gwen Geithman, Princeton, MN (US); Gaylene Johnson, Brooklyn Park, MN (US)

(21) Appl. No.: 13/103,713

(22) Filed: May 9, 2011

(51) Int. Cl. A44B 11/25; G09F 23/00; G09F 3/00; F16B 2/06

(52) U.S. Cl. 24/457; 24/265 BC; 40/640

(57) ABSTRACT

A belt buckle accessory according to the present invention includes a base having opposed front and rear surfaces extending between opposed end edges, the base front and rear surfaces having a generally planar configuration. The accessory includes a sleeve having a sleeve upper end attached to the base rear surface adjacent a base upper edge thereof and having a sleeve lower end attached to the base rear surface adjacent a base lower edge thereof. The sleeve is detached from the base rear surface between the base upper and lower edges. There is indicia positioned on the base front surface.

### BACKGROUND OF THE INVENTION

This invention relates generally to removable belt buckles and, more particularly, to a belt buckle accessory that is selectively attachable and removable from a traditional belt buckle.

One traditional type of belt buckle has a generally rectangular frame with an open center area and a pin for selectively engaging a belt hole when the belt is inserted through the open center area. Another type of belt buckle includes a generally solid base member connected to one end of a belt, the base member having a hook or clasp for engaging a hole adjacent an opposite end of the belt. The solid type of belt buckle may include a fashionable pattern, picture, or company logo.

Although assumably effective for their intended purposes, the existing belt buckles are not easily removable from the belt so as to quickly replace the belt buckle with another having a different fashion, picture, pattern, or logo. Therefore, it would be desirable to have a belt buckle accessory that may be selectively coupled to a traditional frame type belt buckle, the accessory having a generally planar front surface with indicia such as a picture, logo, or other image. Further, it would be desirable to have a belt buckle accessory that will not inadvertently become dislodged from the belt buckle.

### SUMMARY OF THE INVENTION

A belt buckle accessory according to the present invention includes a base having opposed front and rear surfaces extending between opposed end edges, the base front and rear surfaces having a generally planar configuration. The accessory includes a sleeve coupled to the base rear surface adjacent a base upper or lower edge thereof such that a portion of the sleeve is unattached from the base rear surface between the base upper and lower edges so as to enable a belt to be inserted between the sleeve and the base rear surface. There is indicia positioned on the base front surface.

Therefore, a general object of this invention is to provide a belt buckle accessory that enables a generally flat panel base with indicia to be selectively coupled to a belt having a traditional buckle.

Another object of this invention is to provide a buckle accessory, as aforesaid, that quickly slides on and off of a belt buckle.

Still another object of this invention is to provide a buckle accessory, as aforesaid, having fashionable indicia on a front surface.

Yet another object of this invention is to provide a buckle accessory, as aforesaid, that is inexpensive to manufacture and user-friendly to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a belt buckle accessory coupled to a belt buckle according to a preferred embodiment of the present invention;

FIG. 2a is a front view of the belt buckle accessory as in FIG. 1;

FIG. 2b is a side view of the belt buckle accessory as in FIG. 1;

FIG. 3 is a perspective view of the belt buckle accessory as in FIG. 1 removed from a belt buckle;

FIG. 4a is a front view of the belt buckle accessory of FIG. 3;

FIG. 4b is a side view of the belt buckle accessory as in FIG. 3;

FIG. 4c is a rear view of the belt buckle accessory as in FIG. 3;

FIG. 5a is a front view of a belt buckle accessory according to another embodiment of the invention;

FIG. 5b is a side view of the belt buckle accessory as in FIG. 5a;

FIG. 5c is a rear view of the belt buckle accessory as in FIG. 5a;

FIG. 6a is a front view of the belt buckle accessory as in FIG. 5a coupled to a belt and belt buckle; and

FIG. 6b is a side of the belt buckle accessory as in FIG. 6a; and

FIG. 7 is a rear perspective of the belt buckle accessory as in FIG. 5c.

### DESCRIPTION OF THE PREFERRED EMBODIMENT

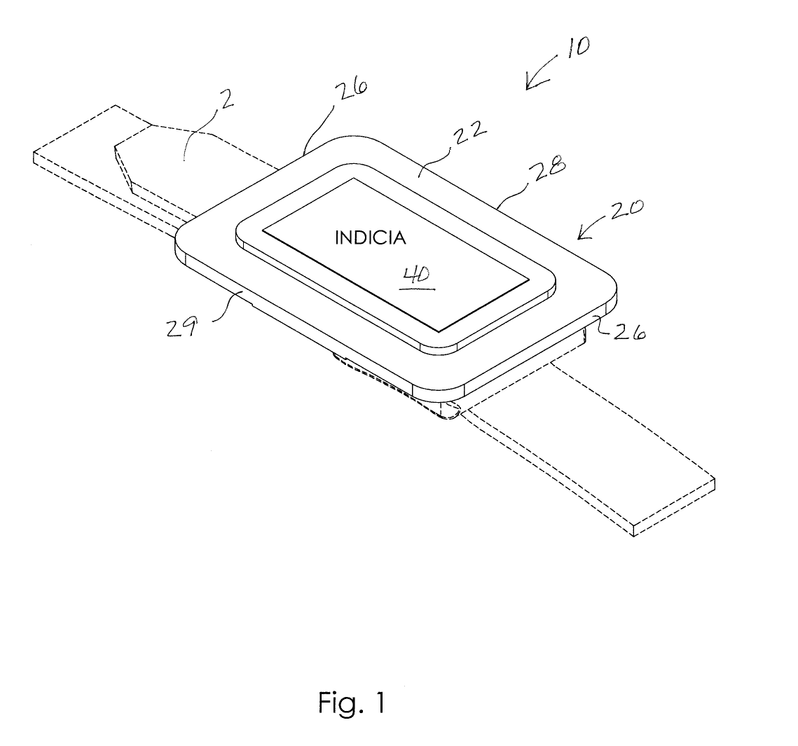

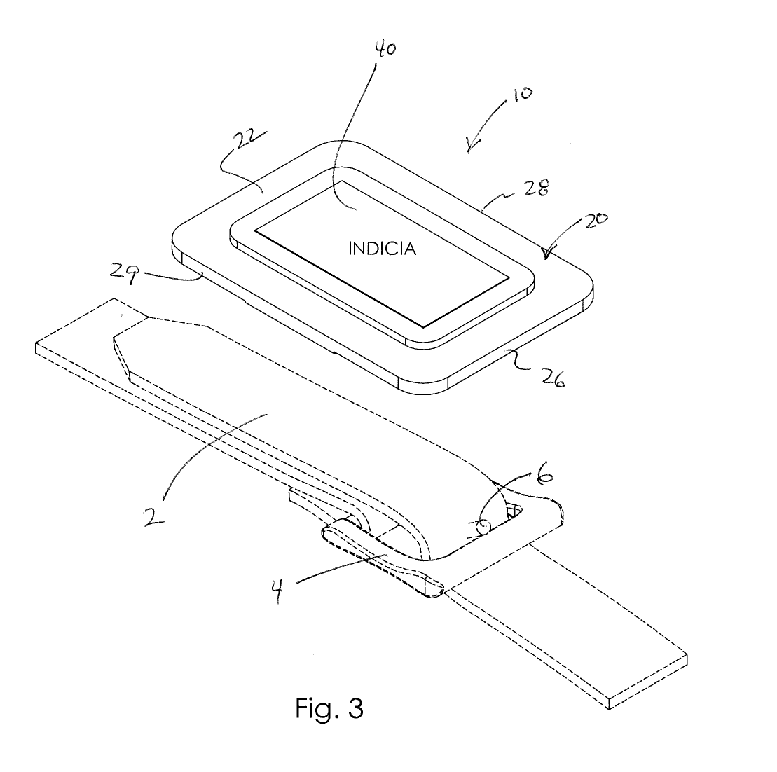

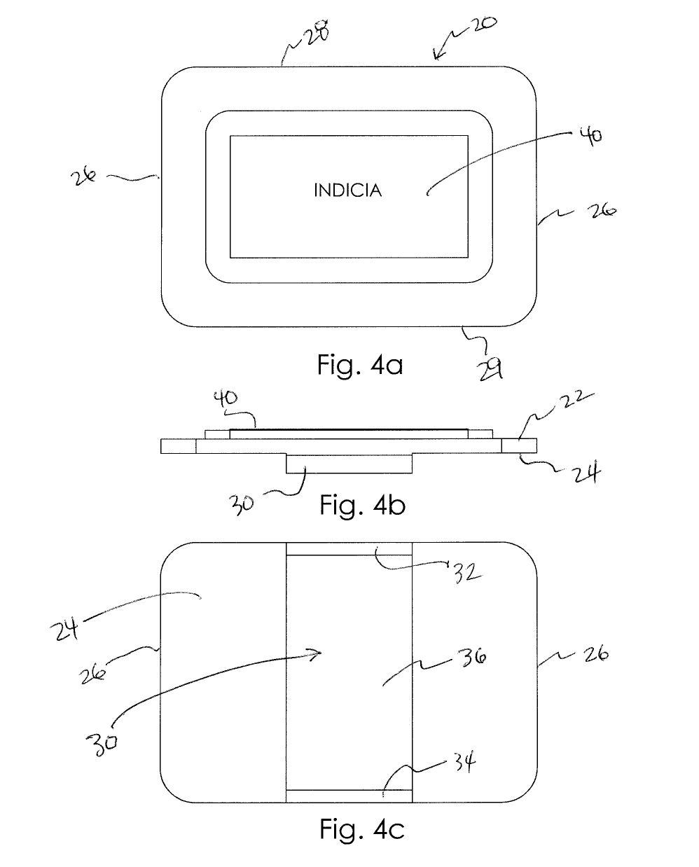

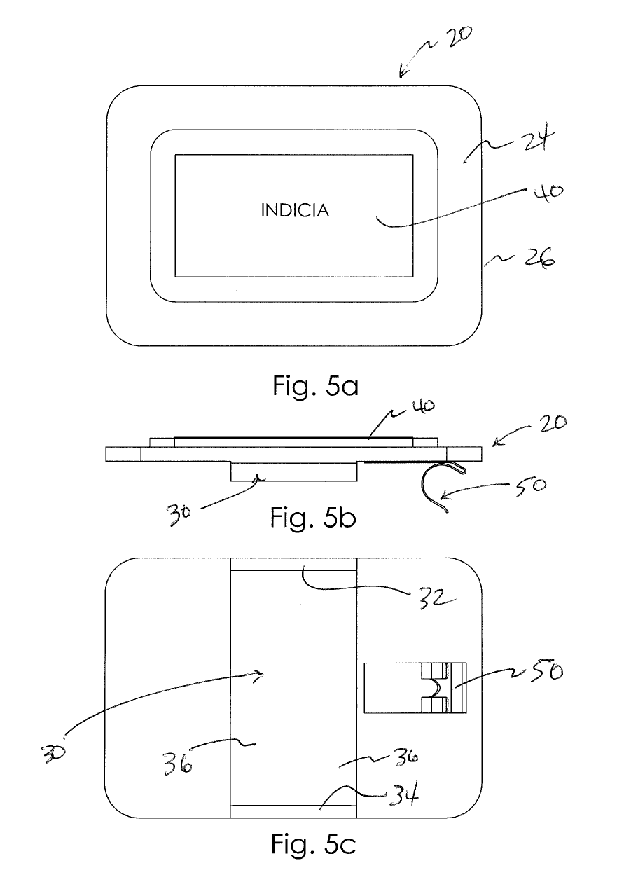

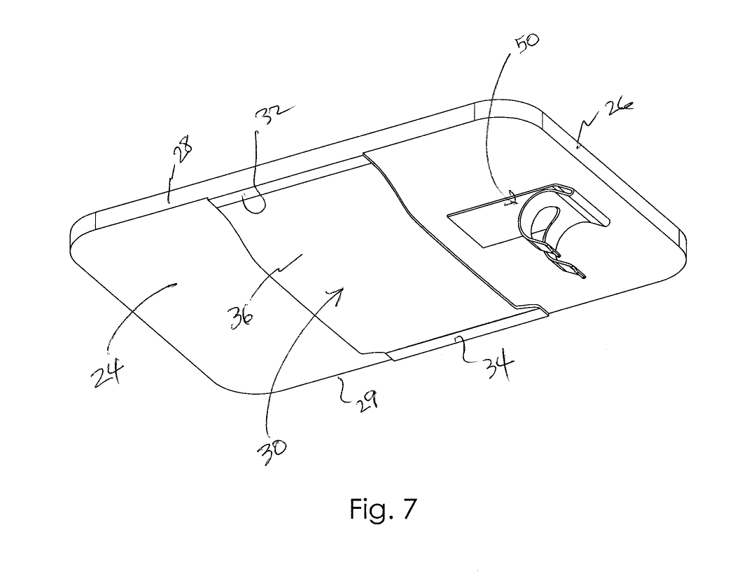

A belt buckle accessory according to embodiments of the present invention will now be described with reference to FIGS. 1 to 7 of the accompanying drawings. The belt buckle accessory 10 according to one embodiment includes a base 20, a sleeve 30 on a rear surface of the base 20, and indicia 40 on a front surface of the base 20.

The belt buckle accessory 10 includes a base 20 having opposed front 22 and rear 24 surfaces, the base 20 having a generally planar configuration. The front 22 and rear 24 surfaces of the base 20 extend between opposed end edges 26 with upper 28 and lower 29 edges extending generally longitudinally between respective end edges 26. The base 20 may include a general rectangular configuration in which upper 28 and lower 29 edges have a length dimension that is longer than a length dimension of said opposed end edges 26, although circular, oval, or other configurations may also work. The base 20 may include a slightly annular or concave configuration relative to the base rear surface 24 so as to conform to the person's body shape, as will be further described later. Alternately, the base 20 may be constructed of a generally resilient or flexible material so that it may flex to conform to a person's abdominal body contour when attached to a belt buckle 4. Additionally, the base 20 may be constructed of metal, hard plastic, resilient plastic, cloth, vinyl, foam, or other material that provides a level of rigidity and moderate flexibility.

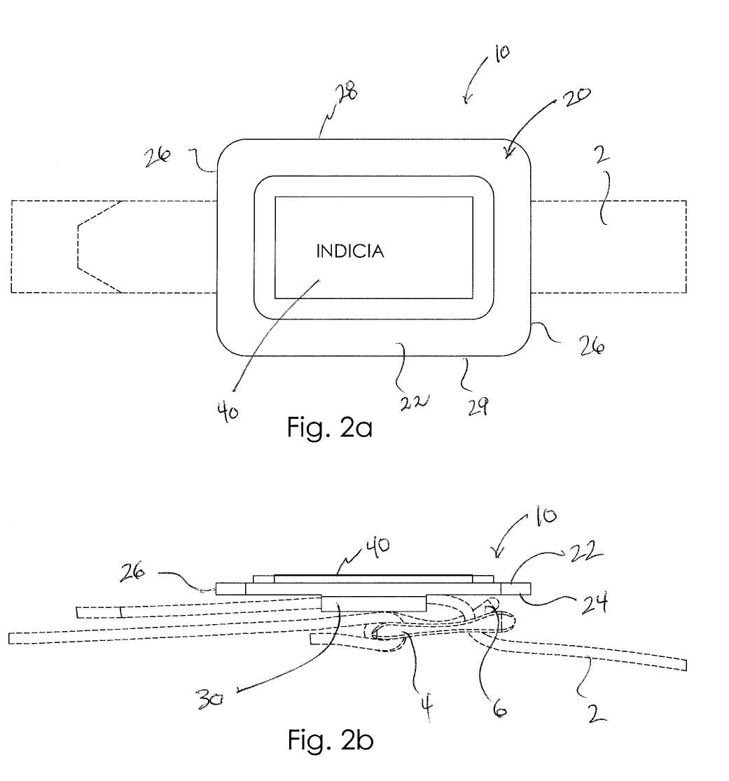

The sleeve 30 includes a sleeve upper end 32 that is attached to the base rear surface 24 adjacent to a base upper edge 28 and a sleeve lower end 34 that is attached to the base rear surface 24 adjacent to a base lower edge 29. The sleeve 30 includes a center portion that extends between the upper 32 and lower 34 ends thereof, the center portion 36 being unattached to the base rear surface 24. The center portion 36 of the sleeve 30 either has a relative length of non-elastic material, such as cloth or leather, that results in “slack” or is constructed of an elastic material such that a belt 2 may be selectively inserted between the center portion 36 and the base rear surface 24 (FIG. 2b), as will be described in more detail later. In some embodiments, the sleeve 30 may only be attached to the base upper edge 28 or to the base lower edge 29 but not both.

The belt buckle accessory 10 includes indicia 40 situated on the front surface 22 of the base 20. Various types of indicia may be included on the base front surface 22. Specifically, one type of indicia 40 may be used singly or a combination of indicia types may be used. The indicia 40 may be ink printing, paint, screen printing, laser printing, lenticular printing, an image affixed with glue or other adhesive, a three dimensional object, a cloth or other textile object, or other types of indicia. It is understood that the indicia 40 may cover substantially the entire front surface 22 or may be limited to an area less than an entirety of the front surface 22. In other words, there may be portions of the front surface 22 that include no indicia at all.

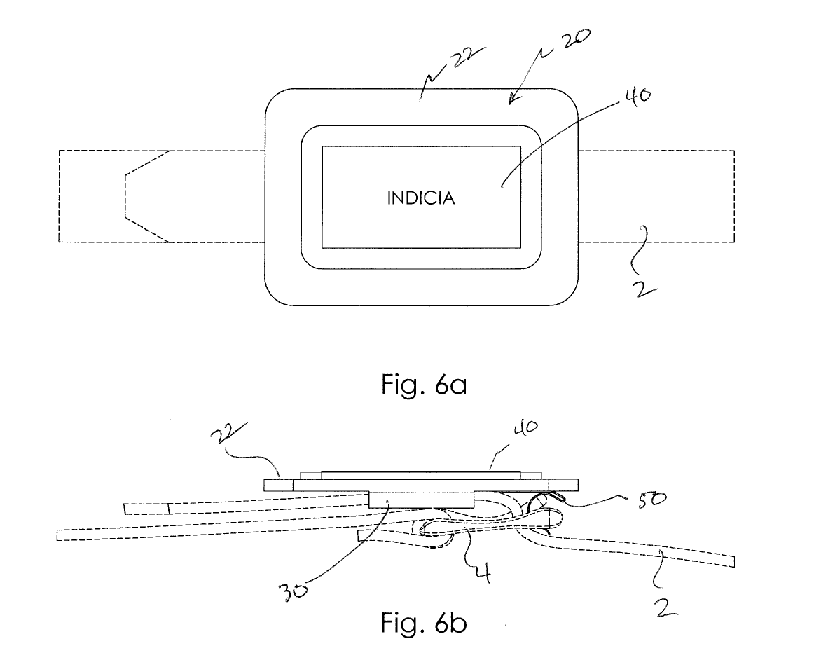

In another aspect of the invention, a clamp member 50 may be attached to the rear surface 24 of the base 20. The clamp member 50 may include a generally C-shaped configuration defining an open side directed toward the trailing end edge 26 of the base 20 although it may work if the open side is directed toward either of the base end edges 26. The clamp member 50 is configured so as to engage a respective frame member of a belt buckle 4 when selectively coupled thereto as shown in FIG. 6b. The clamp member 50 may be constructed of a spring steel material that enables the clamp member 50 to be tightly secured to a belt buckle frame element yet be selectively removable therefrom with a gentle pulling force. Alternatively, the clamp member 50 may include a hook and loop fastener, a snap fastener, a hook, or other structure configurable to engage a belt buckle frame element and keep the base 20 from movement when coupled to a belt and belt buckle.

In another embodiment (not shown), the rear surface 24 of the base 20 may define recess, depression, or cutout. Preferably, the recess is positioned generally beneath the sleeve 30 although it would likely extend toward each end edge 26. The recess would be configured to receive a traditional belt buckle 4 therein when the accessory 10 is coupled thereto. It is understood that by providing a structure to nest a belt buckle 4 into the accessory 10, the accessory 10 with its indicia 40 (potentially raised indicia that extends outwardly from the base front surface 22) will not extend an awkward or undesirable distance out in front of the belt buckle 4.

In use, the belt buckle accessory 10 may be slidably coupled to a person's belt buckle 4. More particularly, an end of a belt 2 may be inserted through the sleeve 30 and then fastened by a pin 6 of the belt buckle 4 engaging a respective belt hole. In doing so, the belt buckle accessory 10 is positioned atop the belt buckle 4 as shown in FIGS. 2a and 2b. If the belt buckle accessory 10 includes the clamp member 50 described above, the belt buckle accessory 10 may be positioned, once a belt 2 has been inserted through the sleeve 30, such that the clamp member 50 engages a trailing frame element of the belt buckle 4 as shown in FIG. 6b.

It is understood that while certain forms of this invention have been illustrated and described, it is not limited thereto except insofar as such limitations are included in the following claims and allowable functional equivalents thereof.

1. A removable belt buckle accessory for use with a belt buckle, comprising:
a base having opposed front and rear surfaces extending between opposed end edges, said base front and rear surfaces having a generally planar configuration;
a sleeve having a sleeve upper end attached to said base rear surface adjacent a base upper edge thereof and having a sleeve lower end attached to said base rear surface adjacent a base lower edge thereof;
wherein said sleeve is unattached from said base rear surface between said base upper and lower edges; and
indicia positioned on said base front surface.

2. The belt buckle accessory of claim 1, wherein said base upper and lower edges are longer than said base end edges, respectively.

3. The belt buckle accessory of claim 2, wherein said base includes a generally rectangular configuration.

4. The belt buckle accessory of claim 3, wherein said indicia is one of screen printing, ink printing, three dimensional object, laser printing, glue-on object, and a textile object.

5. The belt buckle accessory of claim 4, wherein said indicia includes more than one type of indicia.

6. The belt buckle accessory of claim 1, wherein said base plate is constructed of a generally resilient material that conforms to a person's abdominal contour when coupled to a belt buckle.

7. The belt buckle accessory of claim 5, wherein said base front surface includes an area having no indicia.

8. The belt buckle accessory of claim 1, further comprising a clamp member attached to said base rear surface between said sleeve and a respective base end edge, said clamp member having a configuration that is complementary to an end of the belt buckle so as to secure said belt buckle accessory to said belt buckle.

9. The belt buckle accessory of claim 8, wherein said clamp member includes a generally C-shaped configuration having an open end generally directed toward said respective base end edge.

10. The belt buckle accessory of claim 8, wherein said clamp member is one of a spring steel clamp, a hook and loop fastener, a ribbon, a snap, and a hook.

11. The belt buckle accessory of claim 8, wherein said base is constructed of one of metal, hard plastic, resilient plastic, fabric, cloth, vinyl, and foam.

12. The belt buckle accessory of claim 1, wherein said base rear surface defines a recess having a configuration complementary to a configuration of a belt buckle such that the belt buckle to which said base is coupled is received in said recess.

13. The belt buckle accessory of claim 1, wherein said indicia is removably coupled to said base front surface.

14. The belt buckle accessory of claim 1, further comprising:
a clamp member attached to said base rear surface between said sleeve and a respective base end edge, said clamp member having a configuration that is complementary to an end of the belt buckle so as to secure said belt buckle accessory to said belt buckle;
wherein:
said base includes a generally rectangular configuration
said indicia is one of screen printing, ink printing, three dimensional object, laser printing, glue-on object, and a textile object;
said base plate is constructed of a generally resilient material that conforms to a person's abdominal contour when coupled to a belt buckle;
said clamp member includes one of a spring steel clamp, a hook and loop fastener, a ribbon, a snap, and a hook;
said base is constructed of one of metal, hard plastic, resilient plastic, fabric, cloth, vinyl, and foam.

15. The belt buckle accessory of claim 14, wherein said base rear surface defines a recess having a configuration complementary to a configuration of a belt buckle such that the belt buckle to which said base is coupled is received in said recess.
